(19) United States
(12) Patent Application Publication
(10) Pub. No.: US 2025/0356170 A1
(43) Pub. Date: Nov. 20, 2025

(54) ADVERSARIAL DATA ATTACK ESTIMATION BY GENERATIVE ADVERSARIAL NETWORK BASED SYSTEM

(71) Applicant: Telefonaktiebolaget LM Ericsson (publ), Stockholm (SE)

(72) Inventors: Mohamed NAILI, Montreal (CA); Emmanuel THEPIE FAPI, Cote-Saint-Luc (CA); Zhongwen ZHU, Saint-Laurent (CA)

(21) Appl. No.: 18/871,873

(22) PCT Filed: Jun. 8, 2022
(86) PCT No.: PCT/IB2022/055335

§ 371 Date: Dec. 5, 2024

(51) Int. Cl. G06N 3/0475; G06F 21/57; G06N 3/0455; G06N 3/094

(52) U.S. Cl. CPC G06N 3/0475; G06F 21/577; G06N 3/0455; G06N 3/094

(57) ABSTRACT

A method performed by a generative adversarial network, GAN, based system for outputting an estimated adversarial data, EAD, of an attack on an artificial intelligence, AI, model is provided. The method includes classifying a data point from an input data as (i) a real data point, or (ii) a manipulated data point. The method further includes, when the classification is a manipulated data point, outputting the estimated adversarial data including a difference between the manipulated data point and the data point from the input data. The method may further include using the EAD to build a data recovery module.

### TECHNICAL FIELD

The present disclosure relates generally to outputting from a generative adversarial network (GAN) based system an estimated adversarial data (EAD) of an attack on an artificial intelligence (AI) model, and related methods and apparatuses.

### BACKGROUND

A challenge facing AI models is their potential vulnerability to adversarial attacks. An adversarial attack includes generation of an adversarial example(s) or noise in data (e.g., noise in an image). An adversarial example refers to an input(s) to an AI model that purposefully tries to cause the AI model to make a mistake for a given input (e.g., a misclassification of the given input, a mistake in a prediction(s) of the AI model, etc.). See e.g., Xiaoyong Yuan et al., “Adversarial Examples: Attacks and Defenses for Deep Learning”, arXiv:1712.07107v3 (cs) (7 Jul. 2018); “Towards Deep Learning Models Resistant to Adversarial Attacks”, Aleksander Madry, et al., 2019, arXiv:1706.06083v4 (stat) (4 Sep. 2019). As used herein, the terms “artificial intelligence model” or “AI model” includes, without limitation, an AI model(s) and/or a machine learning (ML) model(s). For example, an adversarial example may be a well-designed input that can easily fool a ML model(s) in a testing and/or deployed stage. Adversarial example generation may include, for example, using noise (e.g., from an image) for generation of the adversarial example.

In some approaches, a network architecture that may be referred to as an adversarial network has been adopted in various applications. See e.g., “Anomaly Detection with Generative Adversarial Networks for Multivariate Time Series”, Dan Li, Dacheng Chen, Jonathan Goh, and See-Kiong Ng, arXiv:1809.04758v3 (cs) (15 Jan. 2019); “Multi-head enhanced self-attention network for novelty detection”, Yingying Zhang, Yuxin Gong, Haogang Zhu, Xiao Bai, Wenzhong Tang, Pattern Recognition 107 (2020) 107486. In a GAN, at least a classifier and a generator of adversarial examples may compete. On one hand, the classifier (e.g., referred to as a discriminator) may be trained to classify inputs coming from a real data distribution as “real” and to classify inputs generated by a generator (e.g., an adversarial examples generator) as “fake” (also referred to herein as “manipulated”, “generated”, “synthetic”, and/or “adversarial”). On the other hand, the generator may try to learn how to generate data points that would be labeled as “real” by the discriminator (that is, fool the discriminator). For example, the generator can generate adversarial examples based on a randomly generated input or can be designed as an Auto Encoder (AE) or Variational Auto Encoder (VAE) where the input is a real data point. See e.g., “Adversarial Variational Bayes: Unifying Variational Autoencoders and Generative Adversarial Networks”, Lars Mescheder, Sebastian Nowozin, Andreas Geiger, arXiv:1701.04722v4 (cs) (11 Jun. 2018); Ming qi Hu et al., “Variational Conditional GAN for Fine-grained Controllable Image Generation”, Proceedings of Machine Learning Research 101:1-16, 2019ACML 2019, arXiv: 1909.09979v1 (cs) (22 Sep. 2019). Such an optimization problem may be modeled as follows:

$${min}_{G} {max}_{D} V ( D ; G ) = {E}_{x ∼ p ( x )} ( x ) [ log D ( x ) ] + {E}_{z ∼ p ( z )} ( z ) [ log ( 1 - D ( G ( z ) ) ) ]$$

### Where:

G is generator
D is discriminator
x is a real data point from real data distribution p(x)
z is a fake data point from another data distribution p(z) learned by the generator.

### SUMMARY

As used herein, the phrase “adversarial example” may be interchangeable and replaced with the terms “adversarial attack”, “attack”, “adversarial noise” and/or “noise”. Some approaches (e.g., as discussed above) may focus only on detecting adversarial examples/attacks/noise without estimating the adversarial example/attack/noise. Such approaches lack exploitation of the data including, without limitation, estimating adversarial data. Estimating adversarial data may help not only in assessing the severity of a possible cyber-attack, but also may be leveraged in recovering the intercepted/noisy data when possible.

In various embodiments, a method is performed by a GAN-based system that can help in detecting and estimating noise and/or adversarial examples/attacks. The GAN based system may be used to teach a discriminator not only to detect adversarial examples/attacks/noise, but also to estimate adversarial data (e.g., the adversarial examples/attacks/noise). The method may further include that such adversarial examples/attacks/noise estimation may be used to recover the original input data. The method may further include calculating a severity of such estimated adversarial data.

Potential advantages provided by various embodiments of the present disclosure may include that the estimated adversarial data may be used in denoising/recovering the received input data by removing the estimated adversarial data. For example, if an image is intercepted by a malicious attacker which tries to alter the image, the method may include detection of whether the received image has been altered or not and, if altered, recovering the original image.

Further potential advantages may include that instead of making an AI model learn how to output a similar data (like an autoencoder, for example) to the original data and then comparing and calculating a difference between this output and the input, the method of the present disclosure may include that the AI model learns to output the difference between the manipulated data and the original input data. Thus, the method may eliminate a burden of keeping track of inputs for comparison. Moreover, the difference may be used to recover the original input data and/or to calculate a severity level of the adversarial data (attack/noise). Estimating the severity level of the adversarial data may help in assessing the quality and reliability of the data source. For example, if a data source is providing inputs with high severity scores, the high severity scores may be an indicator of a cyber-attack.

In various embodiments, a method performed by a GAN based system is provided for outputting an estimated adversarial data of an attack on an AI model. The method includes classifying a data point from an input data as (i) a real data point, or (ii) a manipulated data point. The method further includes, when the classification is a manipulated data point, outputting the estimated adversarial data comprising a difference between the manipulated data point and the data point from the input data. As used herein with respect to the method of the present disclosure, the term “real data point” refers to a data point that is trusted or benign (that is, not manipulated/adversarial) as opposed to, e.g., a real number.

In some embodiments, the method further includes training a discriminator and a generator of the GAN based system based on a discriminator loss comprising a first weighted classification loss and a second weighted estimated adversarial data loss.

In some embodiments, the method further includes recovering the data point from the input data from one of (i) a difference between the estimated adversarial data and the input data and (ii) a machine learning model trained to recover the data point.

In some embodiments, the method further includes calculating a level of severity of the attack based on a weighted mean absolute estimated distortion of the real data point and the value of the estimated adversarial data added to the real data point.

In some embodiments, the method further includes reporting the attack with a probability when the score has a value that is greater than a defined severity threshold.

In various embodiments, a node is provided. The node is configured to output from a GAN based system an estimated adversarial data of an attack on an AI model. The node includes processing circuitry, and at least one memory coupled with the processing circuitry. The memory stores program code that is executed by the processing circuitry to perform operations. The operations include classify a data point from an input data as (i) a real data point, or (ii) a manipulated data point. The operations further include, when the classification is a manipulated data point, to output the estimated adversarial data comprising a difference between the manipulated data point and the data point from the input data.

In various embodiments, a node is provided. The node is configured to output from a GAN based system an estimated adversarial data of an attack on an AI model. The node is adapted to perform operations. The operations include classify a data point from an input data as (i) a real data point, or (ii) a manipulated data point. The operations further include, when the classification is a manipulated data point, to output the estimated adversarial data comprising a difference between the manipulated data point and the data point from the input data.

In various embodiments, a computer program product including a non-transitory storage medium including program code to be executed by processing circuitry of a node is provided. Execution of the program code causes the node to perform operations comprising classify a data point from an input data as (i) a real data point, or (ii) a manipulated data point. The operations further include, when the classification is a manipulated data point, to output the estimated adversarial data comprising a difference between the manipulated data point and the data point from the input data.

In various embodiments, a computer program including program code to be executed by processing circuitry of a node is provided. The program code causes the node to perform operations comprising classify a data point from an input data as (i) a real data point, or (ii) a manipulated data point. The operations further include, when the classification is a manipulated data point, to output the estimated adversarial data comprising a difference between the manipulated data point and the data point from the input data.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating a GAN based system in accordance with some embodiments of the present disclosure;

FIG. 2 is a schematic diagram illustrating classification and estimated adversarial data (EAD) generation by a discriminator in accordance with some embodiments of the present disclosure;

FIG. 3 is a schematic diagram illustrating a module for data recovery in accordance with some embodiments of the present disclosure;

FIG. 4 is a schematic diagram illustrating predicting an input data class and its associated EAD in accordance with some embodiments of the present disclosure;

FIG. 5 is a flow chart illustrating abnormality detection and a severity score calculation in accordance with some embodiments of the present disclosure;

FIG. 6 is a flow chart illustrating operations of a GAN based system in accordance with some embodiments of the present disclosure; and

FIG. 7 is a block diagram of a node in accordance with some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

The following explanation of potential problems with some approaches is a present realization as part of the present disclosure and is not to be construed as previously known by others.

As previously referenced, some approaches lack estimation of adversarial data. Estimating adversarial data, however, may help not only in assessing a severity of an attack, but also may be leveraged to recover the original input data.

Various embodiments of the present disclosure may provide solutions to these and other potential problems. A computer-implemented method performed by a GAN based system for outputting an estimated adversarial data of an attack on an AI model is provided. The method includes classifying a data point from an input data as (i) a real data point, or (ii) a manipulated data point; and, when the classification is a manipulated data point, outputting the estimated adversarial data comprising a difference between the manipulated data point and the data point from the input data.

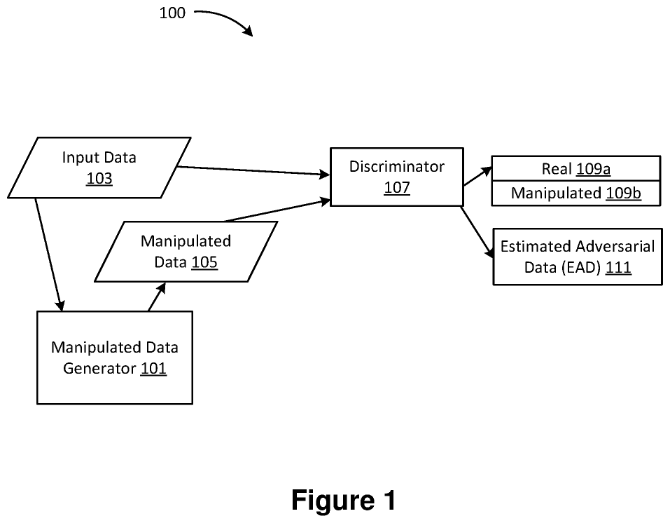

FIG. 1 is schematic diagram illustrating a GAN based system 100 in accordance with some embodiments of the present disclosure. The GAN based system may be referred to as an anti-adversarial generative adversarial network. As illustrated in FIG. 1, GAN based system 100 includes a manipulated data generator 101 (also referred to herein as a generator) and a discriminator 107. Manipulated data generator 101 (e.g., a neural network) and discriminator 107 (e.g., another neural network) are adversarial to one another in generating new, synthetic instances of data that can pass for real data (e.g., benign data). For example, a GAN based system can be used to generate, and then pass or detect, fake images, fake videos, fake voices, etc.

Referring to FIG. 1, manipulated data generator 101 and discriminator 107 receive input data 103. Input data 103 includes collected data, which also may be preprocessed (e.g., data cleansing, feature selection and engineering if needed, normalizing/standardizing if needed, etc.). Responsive to receiving input data 103, manipulated data generator 101 generates and outputs manipulated data 105. As used herein, the term “manipulated data” may be interchangeable and replaced with the terms “fake data”, “generated data”, “synthetic data”, and/or “adversarial data”. Manipulated data generator 101 may be an encoder-decoder, a variational encoder-decoder, etc. Manipulated data generator 101 generates adversarial data 105 based on the received input data 103.

A goal of manipulated data generator 101 is to pass the created

manipulated data instances 105 to discriminator 107 to be deemed by discriminator network 107 as authentic or benign, even though they are fake. Discriminator 107 evaluates the manipulated data instances for authenticity. In other words, discriminator 107 decides whether each instance of manipulated data 105 and input data 103 that it reviews is fake or real. A goal of discriminator 107 is to identify the manipulated data 105 coming from manipulated data generator 101 as fake.

Still referring to FIG. 1, GAN based system 100 is trained using input data 103 that includes “ground truth” data, which is real or authentic (e.g., data classified as real). A manipulated dataset 105 is generated by the manipulated data generator by transforming data from input data 103 into a synthetic fake data instance 105. The synthetic fake data instance 105 is fed into discriminator 107 along with data from the ground truth data form input data 103.

Discriminator 107 operates to classify the manipulated data 105 and input data 103. Given features of a data point (e.g., an instance) of manipulated data 105, discriminator 107 predicts a label or category to which that data belongs (or in other words, maps features to labels). That is, discriminator 107 returns probabilities of labels 109 (e.g., a number having a value between 0 and 1, with 1 representing a prediction of real data (e.g., authentic or benign data) and 0 representing a prediction of manipulated data (e.g., fake data)). Two feedback loops are included. Discriminator 107 is in a feedback loop with the authenticity of the data from the ground truth data, which is known. Manipulated data generator 101 is in a feedback loop with discriminator 107 and incorporates feedback from discriminator 107 on the classification 109 of the data. Thus, discriminator 107 learns how to detect fake data, and manipulated data generator 101 learns how to pass fake data.

Manipulated data generator 101 and discriminator 107 each operate to try to optimize a different and opposing objective function (i.e., a discriminator loss and a generator loss). Their discriminator and generator losses push against each other. Generator loss penalizes manipulated data generator 101 for generating a manipulated data point 105 that discriminator 107 classifies as fake. Manipulated data generator 101, thus, tries to minimize the generator loss. The discriminator loss penalizes discriminator 107 for misclassifying a real data point as fake, or a fake data point created by manipulated data generator 101 as real.

Still referring to FIG. 1, discriminator 107 also outputs estimated adversarial data (EAD) 111. EAD 111 represents the adversarial data (that is, manipulated or fake data). EAD 111 has a same data shape as a data shape of input data 103 and manipulated data 105, respectively. The respective data shapes include a number of features in the data. During training, if the input data 103 and the manipulated data 105, respectively, have a shape S (D^{S}), then a ground truth from discriminator 107 may be given in terms of an expected label 109a/109b and an expected EAD as follows:

If an input data point from input data 103/manipulated data 105 is a real
data point:
Expected label 109 = real
Expected EAD = 0^{s} (that is a shape of the received data point is filled with
zeros, meaning no change in data features' values)
If an input data point from input data 103/manipulated data 105 is a
manipulated data point:
Expected label 109 = manipulated data point
Expected EAD = F(manipulated data point, real data point) where F is a
function such as, e.g., a feature-feature difference between these two data
points.

During training of GAN based system 100, manipulated data generator 101 and discriminator 107 may be trained to classify data points from the received data 103/105, output EAD 111, and calculate losses for the manipulated data generator 101 and discriminator 107.

More specifically, a GAN loss is related to a classification loss of the discriminator 107 (e.g., such as Wasserstein loss function (see e.g., “Adversarial Discriminative Attention for Robust Anomaly Detection”, Daiki Kimura, 2020 IEEE Winter Conference on Applications of Computer Vision (WACV), 1-5 Mar. 2020,10.1109/WACV45572.2020.9093428)) or any other classification loss function). An EAD loss is related to a difference between the expected EAD and the predicted EAD 111 (such as, e.g., Euclidean distance or cosine distance, etc.): EAD loss=difference (expected EAD, predicted EAD 111).

Based on the GAN and EAD losses, a loss function may be built to train the discriminator 107 and the manipulated data generator 101 as follows:

Discriminator loss=α₁ GAN Loss+β₁ EAD Loss, where α₁ is a first weight for the discriminator 107 and β₁ is a second weight for the manipulated data generator 101. The first and second weights may be, e.g., values of hyperparameters to be tuned during training.

Manipulated data generator 101 loss (L₁) may be as follows:

$$If received data 103 / 105 = manipulated data$$

$${L}_{1} = {α}_{2} GAN loss + {β}_{2} EAD loss$$

$$Manipulated data generator 101 loss = \{ \begin{matrix}- {L}_{1} & \\ Or & \\ {γ}_{1} , & if {L}_{1} = 0 where {γ}_{1} is a predefeind minimum loss\end{matrix}$$

In other words, during training, if discriminator 107 misclassifies 109 a received data point, the manipulated data generator 101 is punished with a negative loss (−L₁) during backpropagation in a training path of manipulated data generator 101. On the other hand, if discriminator 107 accurately classifies 109 a received data point and/or accurately generates EAD 111 (that is EAD loss =0), then the loss L₁=0 and a predefined minimum loss Y₁ is backpropagated in a training path of manipulated data generator 101 (e.g., enabling manipulated data generator 101 to learn in small steps while updating the weights).

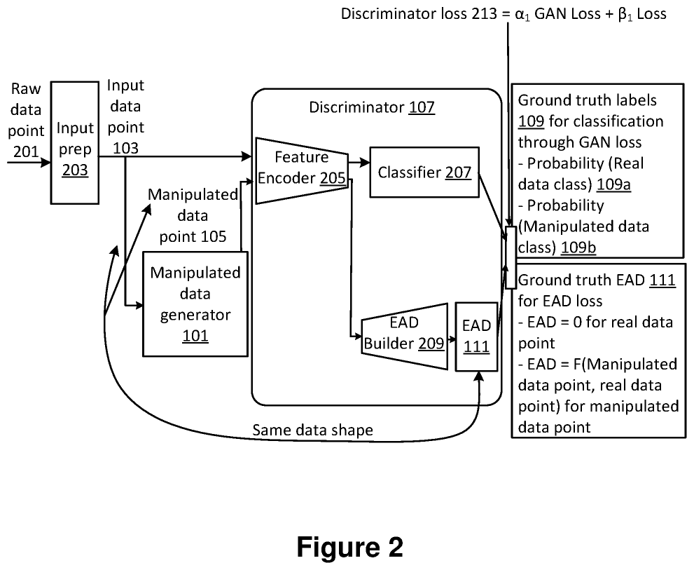

FIG. 2 is a schematic diagram illustrating classification and EAD generation by a discriminator in accordance with some embodiments of the present disclosure. As illustrated in FIG. 2, raw input data point 201 is optionally preprocessed 203 (e.g., data cleansing, feature selection and engineering if needed, normalizing/standardizing if needed, etc.). Input data point 103 is input to feature encoder 205 of discriminator 107 and to manipulated data generator 101. Manipulated data generator 105 generates and outputs adversarial data 105 based on input data point 103, which is input to feature encoder 205 of discriminator 107. Feature encoder 205 encodes features of input data 103 and manipulated data point 105 and outputs the encoded data to classifier 207 and EAD builder 209 of discriminator 107. EAD builder 209 outputs EAD 111, which is a difference between the manipulated data point 105 and the input data point 103. During training, discriminator 107 loss is calculated as discussed herein (e.g., discriminator loss =α₁ GAN Loss+β₁ EAD Loss). Ground truth labels 109 for classification through GAN loss include a probability of a real data class 109a and a probability of a manipulated data class 109b. Ground truth EAD 111 for EAD loss includes EAD=0 for a real data point and EAD=F(manipulated data point, real data point) for a manipulated data point.

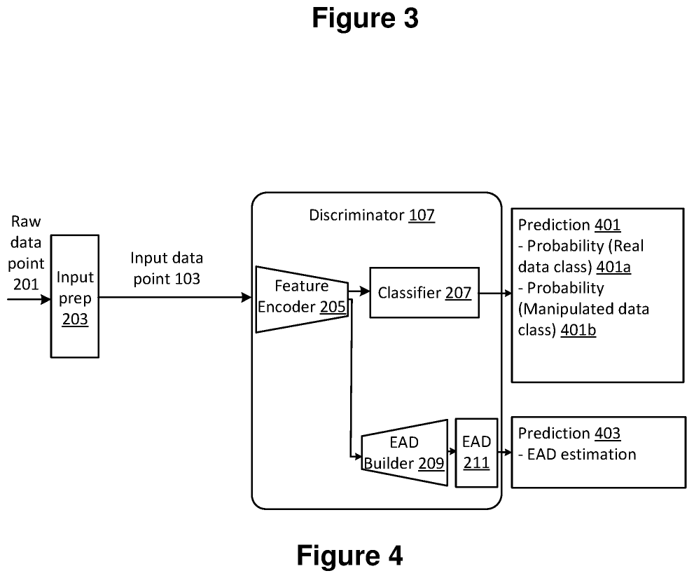

FIG. 3 is a schematic diagram illustrating a module 301 for data recovery in accordance with some embodiments of the present disclosure. As used herein, the term “data recovery” may be interchangeable and replaced with the terms “purifying data” and/or “recovering data”. For example, if an image is intercepted by a malicious attacker that alters the image, then the method of the present disclosure may include detection that the received image has been altered and recovering the original image. A recovered data point 303 may be calculated by module 301 as follows: Recovered data point=C(Input data, EAD), where C is a function that may be used to recover the data point 303 based on a manipulated data point 105 and EAD 111. The function may be a feature−feature difference between the manipulated data point 105 and the EAD 111. Due to the non-linear nature of many real-life applications, however, the function may not be able to recover the original data point. Thus, a neural network-based data recovery (e.g., based on an encoder-decoder architecture) model may be trained and used for that purpose in module 301 for data recovery. Training of such a model can be based on EAD 111/manipulated data points 105 produced by a trained discriminator 107 and generator 101, respectively.

Still referring to FIG. 3, a ground truth for module 301 is a real, classified data point (e.g., a data point classified as benign). Data recovery loss 305 for training module 301 may be: Difference (recovered data point 303, real, input data point 103). The difference may be a distance or a similarity, etc.

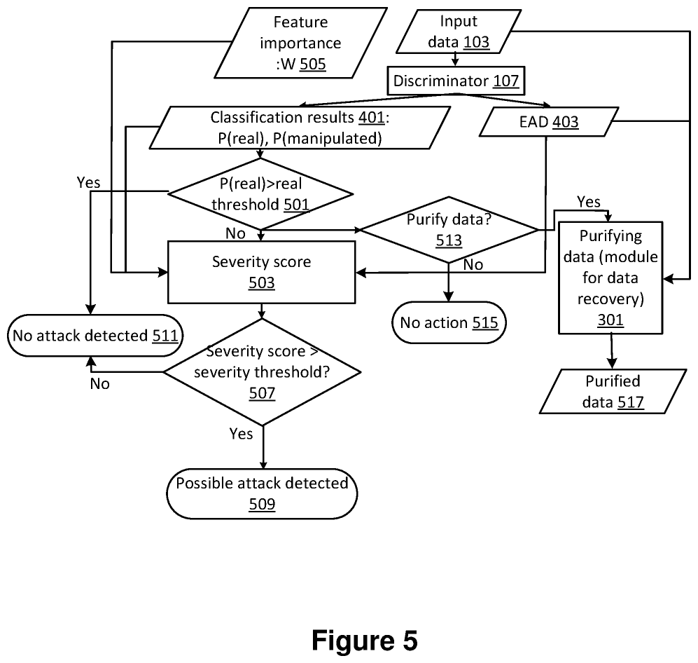

FIG. 4 is a schematic diagram illustrating predicting an input data class and its associated EAD in accordance with some embodiments of the present disclosure. In the inference phase (also referred to herein as predicting), the discriminator 107 predicts 401 a classification of an input data point 103 and outputs a predicted EAD 403. For a prediction 401, discriminator 107 classifies the input data point 103 as: real 401a (or in other words, benign data, as opposed to adversarial or manipulated data) if probability (manipulated data class) is less than or equal to a manipulated data threshold (e.g., a predefined threshold); or manipulated 401b (or in other words an attack) if probability (manipulated data class) is greater than the manipulated data threshold (e.g., the predefined threshold). If prediction 401 is manipulated 401b, module 301 for data recovery may be used to recover a denoised/adversarial-free data point 303.

The method may further include calculating a severity of EAD 111. In an example embodiment, using a matrix or a multi-dimensional array of features importance (that is, weights W) of the shape of the input data 103, a Hadamard-product: W o EAD is used to calculate a Weighted Mean Absolute Estimated Distortion (WMAED):

$$WMAED = Mean ( Abs ( W o EAD ) )$$

In the example embodiment, W can be generated using any explainability algorithm (such as shapely additive explanations (SHAP), local interpretable model agnostic explanations (LIME), etc.) for feature importance on the discriminator 107.

In the example embodiment, if max_WMAED is a predetermined maximum value of WMAED, a Double Weighted Mean Absolute Estimated Distortion (DWMAED) can equal to:

$$DWMAED = P ( Manipulated ) \times WMAED$$

Continuing with the example embodiment, a severity score of the adversarial data can be calculated as follows:

$$Severity score = Min ( 1 , \frac{DWMAED}{max\_WMAED} )$$

In the example embodiment, if the severity score is greater than a defined threshold (e.g., a defined severity threshold value), an attack can be reported with a probability P(manipulated).

FIG. 5 is a flow chart illustrating abnormality detection and a severity score calculation in accordance with some embodiments of the present disclosure. As illustrated in FIG. 5, an overall process is shown of applying a trained discriminator 107 and the module 301 for data recovery to data points for abnormal detection (that is, a classification of a probability of manipulated data) and a corresponding severity score calculation. Input data 103 is input to discriminator 107. Discriminator 107 predicts a classification 401 of a data point from input data 103 with a probability (P) of real (e.g., a probability of P=1) or a probability (P) of manipulated (e.g., a probability of P=0). When the predicted classification 401 is manipulated, discriminator 107 also generates 403 a prediction 403 of EAD that is a difference between the manipulated data point and the input data point.

The result of the classification 401 is (1) used to determine 501 whether a probability (P) of real is greater than a value of a predefined threshold (e.g., a predefined real threshold); and (2) is optionally input to operation 503, to calculate a severity score as discussed herein. If the result of operation 501 is no, the method optionally proceeds to calculating 503 the severity score and, optionally, to operation 513 to determine whether to purify the data (as discussed further herein). If the result of operation 501 is yes, the method proceeds to operation 511 discussed further herein. In operation 503, the severity score may be calculated as discussed herein. The calculated severity score may be used in operation 507 to determine whether the severity score is greater than a value of a predefined threshold (e.g., a severity threshold). If yes, the method proceeds to operation 509, which identifies that a possible attack was detected; and, if no, the method proceeds to operation 511. Operation 511 identifies that no attack was detected based on the severity score being less than or equal to the value of the predefined threshold.

If the determination is no in operation 513 regarding whether to purify the data, the method proceeds to operation 515, where no action is taken. On the other hand, if the determination in operation 513 is yes to purify the data, the method proceeds to the module 301 to purify the data as discussed herein (including, without limitation, that the input data 103 and the EAD 403 are input to module 301). The purified data is output in operation 517.

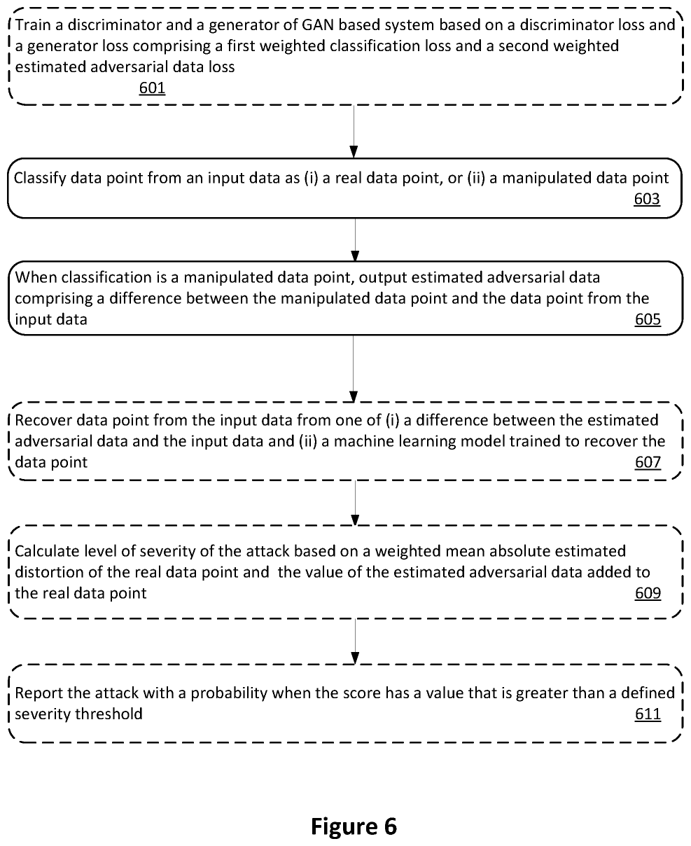

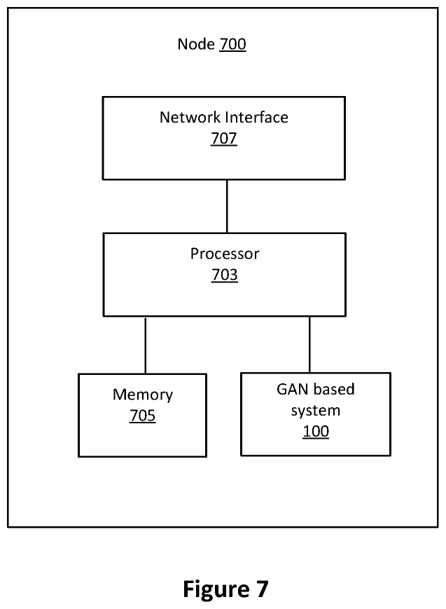

FIG. 6 is a flowchart illustrating operations of a GAN based system (e.g., GAN based system 100) according to some embodiments of the present disclosure. The GAN based system 100 can be the GAN based system 100 of FIG. 7 (as discussed further herein) that is configured for outputting an estimated adversarial data (EAD) of an attack on an AI model. The method includes classifying (603) a data point from an input data as (i) a real data point, or (ii) a manipulated data point. As previously discussed, the term “real data point” of the present method refers to a data point that is trusted or benign (that is, not manipulated/adversarial) as opposed to, e.g., a real number. The method further includes, when the classification is a manipulated data point, outputting (605) the estimated adversarial data comprising a difference between the manipulated data point and the data point from the input data. The classifying (603) and the outputting (605) may be performed by a discriminator of the GAN based system.

In some embodiments, the classifying (603) the data point from an input data as a manipulated data point is based on a probability distribution of a manipulated data class that is greater than a value of a predefined threshold.

In some embodiments, the classifying (603) the data point from an input data as a real data point is based on a probability distribution of a real data class that is less than or equal to a value of a predefined threshold.

The estimated adversarial data (EAD) may comprise a same data shape as the data point from the input data. The same data shape may comprise a same number of features in the estimated adversarial data (EAD) and in the data point from the input data, respectively.

In some embodiments, the method may further include training (601) a discriminator and a generator of the GAN based system based on a discriminator loss and a generator loss comprising a first weighted classification loss and a second weighted estimated adversarial data loss.

The first weighted classification loss may comprise a GAN loss related to a classification loss of the discriminator, and the second weighted estimated adversarial data loss may comprise a difference between an expected estimated adversarial data and the outputted estimated adversarial data.

The first weighted classification loss and the second weighted estimated adversarial data loss may comprise a first weight and a second weight, respectively, and the first and second weights may comprise values of hyperparameters defined during the training.

In some embodiments, the method may further include recovering (607) the data point from the input data from one of (i) a difference between the estimated adversarial data and the input data and (ii) a machine learning model trained to recover the data point. The difference can be measured by distance, similarity, etc. The machine learning (ML) model may be trained based on a plurality of estimated adversarial data and a plurality of manipulated data points produced by a discriminator and a generator, respectively, of the GAN based system. The ML model trained to recover the data point may be trained based on a data recovery loss comprising a difference between a recovered data point and the data point from the input data. The difference can be measured by distance, similarity, etc.

In some embodiments, the method further includes calculating (609) a level of severity of the attack based on a weighted mean absolute estimated distortion of the real data point and the value of the estimated adversarial data added to the real data point. The level of severity may comprise a score. The score may be calculated based on a ratio of a double weighted mean absolute estimated distortion and a predefined maximum value of the weighted mean absolute estimated distortion. The double weighted mean absolute estimated distortion may comprise a probability distribution of a manipulated data class multiplied by the weighted mean absolute estimated distortion.

In some embodiments, the method further includes reporting (611) the attack with a probability when the score has a value that is greater than a defined severity threshold. The probability may be a probability of a manipulated data point output from the classifying (603).

The GAN based system may comprise an anti-adversarial generative adversarial network.

Operations 601, and 607-611 from the flow chart of FIG. 6 may be optional with respect to some embodiments of GAN based systems and related methods.

FIG. 7 is a block diagram illustrating elements of a node 700 (also referred to as a computing device, a server, a gNodeB/gNB, base station, etc.) according to embodiments of inventive concepts. As shown, the node may include network interface circuitry 707 (also referred to as a network interface) configured to provide communications with other nodes and computing devices. The node may also include processing circuitry 703 (also referred to as a processor) coupled to the network interface, and memory circuitry 705 (also referred to as memory) coupled to the processing circuitry. The memory circuitry 705 may include computer readable program code that when executed by the processing circuitry 703 causes the processing circuitry to perform operations according to embodiments disclosed herein. According to other embodiments, processing circuitry 703 may be defined to include memory so that a separate memory circuitry is not required. The node may include the GAN based system 100.

As discussed herein, operations of the GAN based system 100 may be performed by processing circuitry 703, the GAN based system 100, and/or network interface 707. For example, processing circuitry 703 may control network interface 707 to transmit downlink communications through network interface 707 to one or more nodes or computing devices and/or to receive uplink communications through network interface 707 from one or more nodes or computing devices. Moreover, modules may be stored in memory 705 and/or GAN based system 100, and these modules may provide instructions so that when instructions of a module are executed by processing circuitry 703, processing circuitry 703 performs respective operations (e.g., operations discussed herein with respect to example embodiments relating to GAN based systems.

According to some embodiments, node 700 and/or an element(s)/function(s) thereof may be embodied as a virtual node/nodes and/or a virtual machine/machines. For example, the GAN based system of the present disclosure (that is, at least the manipulated data generator 101 and the discriminator 107) may be trained in a cloud-based implementation. Moreover, discriminator 107 may be deployed in the cloud or in an Internet of things (IoT) device(s). A cloud-based deployment may include a cloud based node 700 communicatively connected a network (e.g., a 5G network). The network may include communication connections to a plurality of nodes or computing devices. The network, e.g., a 5G network, may include an access network, such as a radio access network (RAN) and a core network which includes one or more core network nodes. The access network may include one or more access network nodes, such as node 700, or any other similar 3rd Generation Partnership Project (3GPP) access node or non-3GPP access point. The node 700 may facilitate direct or indirect connection of other nodes and/or computing devices, such as by connecting nodes or computing devices to the network over one or more wireless connections.

An IoT device may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A computing device in the form of an IoT device comprises circuitry and/or software in dependence of the intended application of the IoT device in addition to other components as described in relation to the node 700 in FIG. 7.

As yet another specific example, in an IoT scenario, a computing device may represent a machine or other device that performs monitoring and/or measurements, and transmits the results of such monitoring and/or measurements to another computing device and/or a node. The computing device may in this case be an M2M device, which may in a 3GPP context be referred to as an MTC device. As one particular example, the computing device may implement the 3GPP NB-IOT standard. In other scenarios, a computing device may represent a vehicle, such as a car, a bus, a truck, a ship and an airplane, or other equipment that is capable of monitoring and/or reporting on its operational status or other functions associated with its operation.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the cloud-based implementation may include any number of wired or wireless networks, nodes, computing devices, and/or any other components or systems that may facilitate or participate in the communication of data and/or signals whether via wired or wireless connections. The cloud-based implementation may include and/or interface with any type of communication, telecommunication, data, cellular, radio network, and/or other similar type of system.

As a whole, the communication systems of FIGS. 1-5 enable connectivity between the GAN based system, nodes, and computing devices. In that sense, the communication systems may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

Although the GAN based system and node described herein may include the illustrated combination of hardware components, other embodiments may comprise computing devices with different combinations of components. It is to be understood that these computing devices and nodes may comprise any suitable combination of hardware and/or software needed to perform the tasks, features, functions, and methods disclosed herein. Determining, calculating, obtaining or similar operations described herein may be performed by processing circuitry, which may process information by, for example, converting the obtained information into other information, comparing the obtained information or converted information to information stored in the computing device, and/or performing one or more operations based on the obtained information or converted information, and as a result of said processing making a determination. Moreover, while components are depicted as single boxes located within a larger box, or nested within multiple boxes, in practice, the GAN based system, nodes, and computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Further definitions and embodiments are discussed below.

In the above-description of various embodiments of the present disclosure, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A computer-implemented method performed by a generative adversarial network, GAN, based system for outputting an estimated adversarial data of an attack on an artificial intelligence, AI, model, the method comprising:
classifying a data point from an input data as (i) a real data point, or (ii) a manipulated data point; and
when the classification is a manipulated data point, outputting the estimated adversarial data comprising a difference between the manipulated data point and the data point from the input data.

2. The method of claim 1, wherein the classifying and the outputting are performed by a discriminator of the GAN based system.

3. The method of claim 1, wherein the classifying the data point from an input data as a manipulated data point is based on a probability distribution of a manipulated data class that is greater than a value of a predefined threshold.

4. The method of claim 1, wherein the classifying the data point from an input data as a real data point is based on a probability distribution of a real data class that is less than or equal to a value of a predefined threshold.

5. The method of claim 1, wherein the estimated adversarial data comprises a same data shape as the data point from the input data.

6. The method of claim 5, wherein the same data shape comprises a same number of features in the estimated adversarial data and in the data point from the input data, respectively.

7. The method of claim 1, further comprising:
training a discriminator and a generator of the GAN based system based on a discriminator loss and a generator loss comprising a first weighted classification loss and a second weighted estimated adversarial data loss.

8. The method of claim 7, wherein (i) the first weighted classification loss comprises a GAN loss related to a classification loss of the discriminator, and (ii) the second weighted estimated adversarial data loss comprises a difference between an expected estimated adversarial data and the outputted estimated adversarial data.

9. The method of claim 7, wherein the first weighted classification loss and the second weighted estimated adversarial data loss comprise a first weight and a second weight, respectively, and the first and second weights comprise values of hyperparameters defined during the training.

10. The method of claim 1, further comprising:
recovering the data point from the input data from one of (i) a difference between the estimated adversarial data and the input data and (ii) a machine learning model trained to recover the data point.

11. The method of claim 10, wherein the machine learning model is trained based on a plurality of estimated adversarial data and a plurality of manipulated data points produced by a discriminator and a generator, respectively, of the GAN based system.

12. The method of claim 10, wherein the machine learning model trained to recover the data point is trained based on a data recovery loss comprising a difference between a recovered data point and the data point from the input data.

13. The method of claim 1, further comprising:
calculating a level of severity of the attack based on a weighted mean absolute estimated distortion of the real data point and the value of the estimated adversarial data added to the real data point.

14. The method of claim 13, wherein the level of severity comprises a score.

15. The method of claim 14, wherein the score is calculated based on a ratio of a double weighted mean absolute estimated distortion and a predefined maximum value of the weighted mean absolute estimated distortion.

16. The method of claim 15, wherein the double weighted mean absolute estimated distortion comprises a probability distribution of a manipulated data class multiplied by the weighted mean absolute estimated distortion.

17. The method of claim 14, further comprising:
reporting the attack with a probability when the score has a value that is greater than a defined severity threshold.

18. The method of claim 17, wherein the probability is a probability of a manipulated data point output from the classifying.

19. The method of claim 1, wherein the GAN based system comprises an anti-adversarial generative adversarial network.

20. A node configured to output from a generative adversarial network, GAN, based system an estimated adversarial data of an attack on an artificial intelligence, AI, model, the node comprising:
processing circuitry;
memory coupled with the processing circuitry, wherein the memory includes instructions that when executed by the processing circuitry causes the node to perform operations comprising:
classify a data point from an input data as (i) a real data point, or (ii) a manipulated data point; and
when the classification is a manipulated data point, output the estimated adversarial data comprising a difference between the manipulated data point and the data point from the input data.

21.-27. (canceled)
